(19) United States
(12) Patent Application Publication
(10) Pub. No.: US 2018/0143709 A1
(43) Pub. Date: May 24, 2018

(54) OPTICAL SENSOR APPARATUS WITH ADDITIONAL CAPACITIVE SENSORS

(71) Applicant: PREH GMBH, Bad Neustadt a. d. Saale (DE)

(72) Inventors: Manuel STOTZEM, Wülfershausen (DE); Andreas KAIL, Bad Neustadt a.d. Saale (DE)

(73) Assignee: PREH GMBH, Bad Neustadt a. d. Saale (DE)

(21) Appl. No.: 15/736,117

(22) PCT Filed: May 19, 2016
(86) PCT No.: PCT/EP2016/061315

§ 371 Date: Dec. 13, 2017

(30) Foreign Application Priority Data
Jul. 1, 2015 (DE) 10 2015 110 613.2
Mar. 2, 2016 (DE) 10 2016 103 722.2

(51) Int. Cl. G06F 3/044; G06F 3/042; G06F 3/041; G06K 9/00; B60R 16/00

(52) U.S. Cl. CPC G06F 3/044; G06F 3/0421; B60R 16/005; G06K 9/0004; G06K 9/0002; G06F 3/0416

(57) ABSTRACT

The present disclosure relates to a sensor device for arrangement in a motor vehicle, including: a transmitting unit for emitting an optical signal into a space region of a passenger compartment of the motor vehicle; a receiving unit for sensing the optical signal; an evaluation unit for assigning a switching function and/or controlling function to the reflected optical signal; a cover which is transmissive with respect to the optical signal and disposed between the passenger compartment and the transmitting unit; and further, a capacitive sensor with at least one electrode for generating a measuring capacitance sensing the passenger compartment at least in some portions, and means for detecting a capacitance change of the measuring capacitance; and wherein the evaluation unit is further designed to vary the switching function and/or controlling function and/or to vary the transmitting power of the transmitting unit in accordance with the capacitance change.

This application claims priority under 35 U.S.C. § 371 to the International Application No. PCT/EP2016/061315, filed May 19, 2016, and to the German Application No. 102015110613.2, filed Jul. 1, 2015, now pending, and to the German Application No. 102016103722.2, filed Mar. 2, 2016, now pending, the contents of which are hereby incorporated by reference.

The present disclosure relates to a sensor device for arrangement in a motor vehicle, which comprises a transmitting unit for emitting an optical signal into the passenger compartment and a receiving unit for sensing the optical signal reflected from the passenger compartment. The sensor device is configured to expose a space region located in a passenger compartment to an optical signal and to detect a reflected optical signal from this space region. Thus, the sensor device is configured as a reflection light barrier, also referred to as an open light barrier. An optical signal in the sense of the present disclosure is a pulsed or a continuous laser beam, for example. For example, the optical transmission signal is also a pulsed or continuous light generated by a light-emitting diode (LED). The sensor device according to the present disclosure may have many areas of application; accordingly, the space region exposed to the optical signal by the sensor device may have different positions and extents within the passenger compartment. A drawback of all generic sensor devices is that they radiate into the passenger compartment due to their characteristics as an open light barrier, and that thus, their transmitting unit as a light source may distract the driver, because even in the case of an emission of infrared light, which as such is imperceptible to the human eye, the actual light source is perceived as a weakly glowing object and may distract the driver, particularly if it is integrated into a steering wheel.

Furthermore, an arrangement of objects not in accordance with their intended use in the passenger compartment may result in reflections, which leads to the sensor device erroneously assigning a switching or controlling function to this reflection. This problem exists particularly if the sensor device is disposed in a steering wheel, because here, due to the movement of the steering wheel and its actuation, reflected light signals may be incident upon the receiver that have no connection to the actual function of the sensor device, for example as a fingerprint scanner or as an optical input mouse. There is therefore a need for an addition sensor system for verifying the plausibility of the detection carried out by the optical device.

In addition to the desire for a detection that avoids additional function errors and verifies the optical detection, the device is also subject to the usual vehicle construction requirements of saving construction space and weight.

Against this background, the inventors set themselves the object of improving an optical sensor device directed into the passenger compartment in such a way that it detects more reliably and/or that it can be operated conservatively with respect to energy consumption and the environment, including human sensory perception, and that, in particular, the sensor device is designed to save construction space. This object is solved by means of a sensor device according to claim 1, as well as by the use according to the independent claim. Advantageous embodiments are in each case the subject matter of the dependent claims. It is to be noted that the features cited individually in the patent claims can be combined in any technologically meaningful manner and present other embodiments of the present disclosure. The description, in particular in connection with the figures, additionally characterizes and specifies the present disclosure.

The present disclosure relates to a sensor device for arrangement in a motor vehicle. It comprises a transmitting unit for emitting an optical signal into the passenger compartment. The sensor device comprises a receiving unit for sensing the optical signal reflected from the passenger compartment. The space region exposed to the optical signal is predetermined by the arrangement of the transmitter and the receiver or the arrangement of their emission or reception characteristics. In this case, the transmitter and the receiver are disposed in such a way that at least a partial overlap is provided. The transmitting and reception characteristic are oriented depending on the case of application. With regard to the exposed space region and therefore the detection result, and therefore with respect to the application, the sensor device is not limited. For example, the optical sensor is designed to detect smoke and/or combustion vapors in the passenger compartment, and the exposed space region thus substantially senses the entire passenger compartment. Preferably, the exposed space region is disposed immediately adjacent to the cover and extends up to a few centimeters above the cover. For example, this is a so-called fingerprint scanner for generating an identification code, or a scanner for recognizing the movement of an inputting means, such as a finger, through the exposed space region, for example across a surface of the cover.

The sensor device according to the present disclosure further comprises an evaluation unit for assigning a switching function and/or controlling function to the reflected optical signal.

According to the present disclosure, a cover, which is transmissive with respect to the emitted optical signal, is disposed at least between the passenger compartment and the transmitting unit, and preferably also between the passenger compartment and the receiving unit. For example, the cover is translucent or transparent.

According to the present disclosure, the sensor device further comprises a capacitive sensor with at least one electrode for generating a measuring capacitance sensing the passenger compartment at least in some portions, preferably at least the space region exposed to the optical signal, for example due to an electric field pointing into the passenger compartment, and means for detecting a capacitance change of the measuring capacitance.

According to the present disclosure, the evaluation unit is further designed to vary the switching function and/or controlling function and/or to vary the transmitting power of the transmitting unit in accordance with the capacitance change. Varying is understood to be, for example, also the blocking or permitting of the switching function or the switching of the transmitting function of the transmitting unit on or off. Thus, the capacitive sensor serves, for example, for verifying the plausibility of the detection result obtained on the basis of the optical signal. For example, the capacitive sensor serves for activating the transmitting unit or increasing its power only if a capacitance change is detected. For example, the capacitive sensor serves for differentiating an optical reflection signal unintentionally produced by dirt or other influences (sunlight) from an actual signal to be detected, such as it is produced by a finger present in the space region. Thus, the reliability of detection is increased.

The capacitive sensor has, for example, one electrode or several, for example two, electrodes electrically insulated from each other, for generating the field.

Preferably, the sensor device emits light in the infrared range as an optical signal. The spectral range between 10-3 m and 7.8×10−7 m is considered to be infrared. Preferably, the spectral range of the optical signal is in the near-infrared range. This range of the infrared light ranges from 780 nm to 3 μm.

Preferably, the at least one electrode of the capacitive sensor is disposed between the transmitting unit and the cover and/or in the area surrounding the transmitting unit and/or on the cover. For example, the electrode is disposed on a common circuit board, which also carries the transmitting and receiving units. Preferably, the at least one electrode is disposed outside the space region exposed to the optical signal is applied.

As was already mentioned, the sensor device is designed for sensing the optical signal reflected by a finger located on the cover and for determining an operating input or for generating an identification code in accordance with the sensed optical signal.

Preferably, the evaluation unit is designed for determining the operating input by moving the finger along the surface of the cover based on a change of a speckle pattern of the optical signal sensed by the receiving unit.

Preferably, the field and/or the means for detecting capacitance changes of the field are designed to detect a touch of a finger on a surface of the cover, preferably exclusively a touch of a finger on the cover.

For example, the cover is made from a plastic, preferably a thermoplastic material. Preferably, the plastic is translucent or transparent.

According to a preferred embodiment, the cover is configured to be cup-shaped and the transmitting unit, the receiving unit and the evaluation unit, if necessary also the at least one electrode, are accommodated in a cavity resulting from the cup shape of the cover, in order to protect the electronic components.

The transmitting unit, the receiving unit and the evaluation unit are disposed on a common circuit board (5) in order to save construction space. For example, the circuit board is disposed so as to close the above-mentioned cavity of the cup-shaped cover. Thus, the cover and the cavity form a two-part housing around the electronic components, such as the transmitting unit, the receiving unit and the evaluation unit, if necessary including the electrode, in order to protect them.

Preferably, the electrode is disposed on the cup wall, preferably on the inner face of the cup wall facing the cavity. In one embodiment, the electrode also extends across the cup bottom facing towards the cavity, wherein, for example, a “window” not covered by the electrode remains for the passage of the optical signal. Preferably, the electrode is formed by a metallic coating, preferably an aluminum coating, of the cover. For example, the metallic coating is deposited on the cover by vapor deposition.

Preferably, the transmitting unit is a semiconductor laser diode, preferably a semiconductor laser with a surface emitter design, also referred to as vertical-cavity surface-emitting laser diode. Preferably, this is a laser diode with an SMD design.

Preferably, the capacitance change of the measuring capacitance is detected by means of a reference capacitance. For example, the means for detecting a capacitance change comprise a reference circuit part for periodically charging and discharging in a defined manner the predetermined reference capacitance, and a measuring circuit part for periodically charging and discharging in a defined manner the measuring capacitance to be determined, and at least one circuit part for forming at least one quantity characterizing the progression over time of the charging of the reference capacitance and for forming at least one quantity characterizing the progression over time of the charging of the measuring capacitance, and a circuit part for comparing the at least one quantity characterizing the progression over time of the charging of the reference capacitance with the at least one quantity characterizing the progression over time of the charging of the measuring capacitance and for drawing a conclusion as to the value of the measuring capacity based on the comparison. In this case, the change over time of the latter is a measure for the capacitance change according to the present disclosure of the measuring capacitance.

The present disclosure further relates to an operating member which comprises a switching means and a movably mounted actuating part, wherein the actuating part acts on the switching means in order to change the switching state of the switching means. Furthermore, returning means for returning the actuating part into an initial position may be provided. An electro-mechanical key switch, for example, is realized in this manner. In this case, the sensor device in one of the above-described embodiments defines the actuating part. For example, the cover defines an operating surface of the actuating part facing towards the operator. In one embodiment, the operating member according to the present disclosure is an operating member of an assembly (cluster) of operating members that have a different configuration from the operating member and that are grouped so as to surround the operating member according to the present disclosure.

The present disclosure further relates to a motor vehicle steering wheel with the operating member described above. Preferably, the operating member is disposed in a steering wheel spoke connecting the impact absorber (also referred to as the steering wheel hub) with the steering wheel rim.

The above-described sensor device is preferably used in a motor vehicle. Accordingly, the present disclosure particularly relates to an assembly consisting of a motor vehicle steering wheel with the sensor device in one of the above-described embodiments.

The present disclosure as well as the technical environment will be explained in more detail below with reference to the figures. It must be remarked that the Figures depict a particularly preferred embodiment of the present disclosure, but that the latter is not limited thereto.

In the figures:

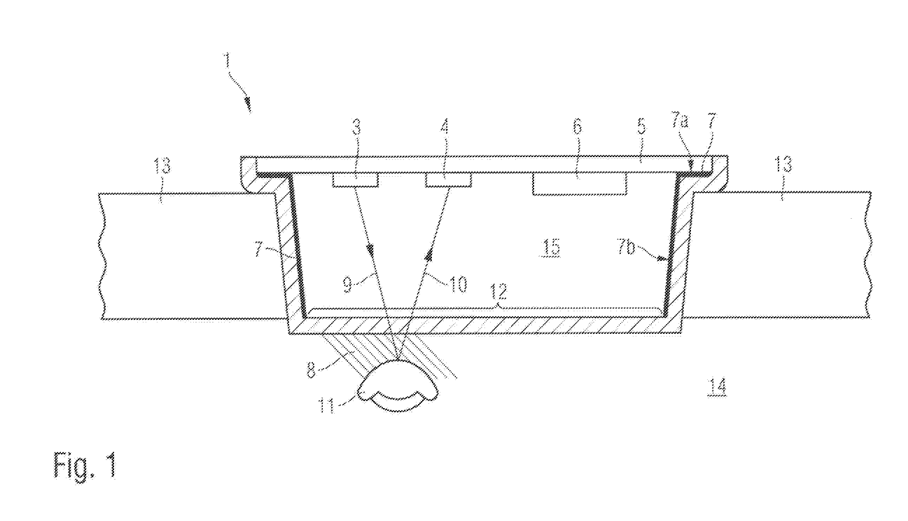

FIG. 1 is a sectional view of the first embodiment of the sensor device according to the present disclosure;

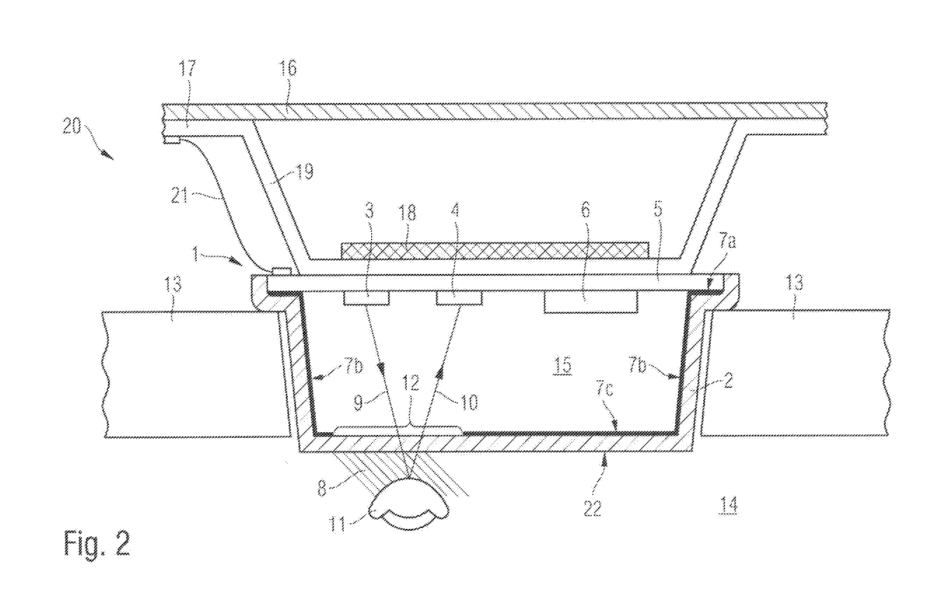

FIG. 2 is a sectional view of an operating member 20 according to the present disclosure with a second embodiment of the sensor device according to the present disclosure;

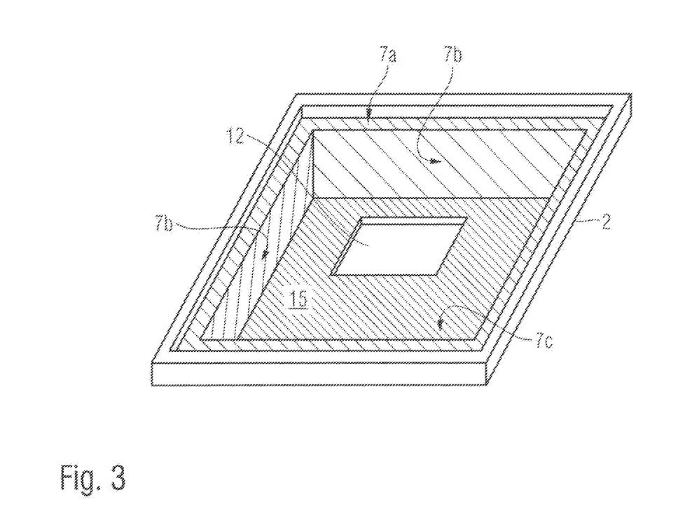

FIG. 3 is a perspective detailed view of the second embodiment of the sensor device according to the present disclosure.

FIG. 1 shows a first embodiment of the sensor device 1 according to the present disclosure. The sensor device 1 has a translucent, cup-shaped cover 2. The cover 2 is inserted into an opening of a panel 13 which delimits a vehicle interior, also referred to as passenger compartment, at least in some portions. The cup-like cover 2 defines a cavity in which essential electronic elements 3, 4, 6 and a circuit board 5 are accommodated. The cup bottom of the cup-shaped cover 2 defines a window 12 into the passenger compartment 14, and, on the side thereof facing away from the cavity, a surface facing towards and delimiting the passenger compartment 14. A space region 8, which is, inter alia, monitored optically by the sensor device 1 according to the present disclosure, is adjacent to this surface of the cover 2. In the present case, the optical monitoring unit is a so-called fingerprint scanner. This optical monitoring unit comprises a transmitting unit 3 in the form of a semiconductor laser diode which emits an optical signal 9 into the space region 8 of the passenger compartment 14, and a receiving unit 4 for sensing the optical signal 10 reflected from the space region 8 of the passenger compartment 14, as it is caused, for example, by a finger 11 shown in FIG. 1. In order to activate the transmitting unit 3 and thus vary its transmitting power only when the finger 11 approaches the cover 2, a capacitive sensor is also provided, which defines a measuring capacitance sensing the space region 8. The measuring capacitance is defined by an electrode 7 producing an electrical field directed into the passenger compartment. The electrode 7 is configured as a metallic, continuous coating of the inner face of the peripheral cup wall 7b facing towards the cavity 15 and as a supporting edge 7a of the cover 2 provided for supporting the circuit board 5. Through the support edge 7a, the electrode 7 is electrically contacted with a conductor path of the circuit board 5. When the approach of the finger 11 towards the cover is detected through a corresponding change of the measuring capacitance, the evaluation unit 6 is to activate the transmitting unit 3, and when a sufficient distance of the finger 11 from the cover is detected through a corresponding change of the measuring capacitance, to deactivate the transmitting unit 3.

FIG. 2 shows an operating member 20 according to the present disclosure, wherein a second embodiment of the sensor device 1 according to the present disclosure defines an actuating part. The embodiment of the sensor device 1 shown in FIG. 2 differs from the first embodiment shown in FIG. 1 substantially by the configuration of the electrode 7. In this embodiment according to FIG. 2, the electrode 7 also extends over the surface 7c of the cup bottom of the cover 2 facing towards the cavity 15, with a window 12 remaining, which is sufficient for the optical monitoring unit consisting of the transmitting unit 3 and the receiving unit 4, as is apparent from FIG. 3, which shows a perspective view of the cavity 15 of the cover 2. The sensor device 1 is movably integrated into an opening of a panel of a cluster of other operating members, which are not shown and which are disposed in a spoke of a steering wheel. The sensor device 1 defines an actuating part of the operating member 20 according to the present disclosure. The surface 22 of the cover 2 facing towards the operator defines an actuating surface. On the side facing away from the operator and adjacent to the circuit board 5, a switching means 19 in the form of a switching dome of a keyboard mat 17 consisting of an elastic material is provided, wherein the switching dome 19, with its contact pill 18 consisting of a conductive material, is disposed above two contact surfaces disposed on another circuit board 16. An electrically conductive connection in the form of a flexible conductor 21 is provided between the other circuit board and the sensor device 1. The actuating part 1, i.e. the sensor device 1, cooperates with the switching dome 19 in such a manner that in the latter's final position, when the sensor device 1 has been pressed downwards against the restoring force caused by the elastic switching dome 19, the contact surfaces located on the other circuit board 16 are connected with each other in an electrically conductive manner by the contact with the contact pill 18, so that a switching state is thus changed.

1. A sensor device for arrangement in a motor vehicle, comprising:
a transmitting unit configured to emit an optical signal into an enclosed compartment;
a receiving unit configured to sense the optical signal reflected from the interior compartment;
an evaluation unit for assigning to the optical signal at least one of: a switching function and a controlling function;
a cover which is transmissive with respect to the optical signal and disposed between the interior compartment and the transmitting unit; and
a capacitive sensor with at least one electrode for generating a measuring capacitance sensing the passenger compartment at least in some portions, and configured to detect a capacitance change of the measuring capacitance; and wherein the evaluation unit is further designed to vary at least one of: the switching function, the controlling function and the transmitting power of the transmitting unit in accordance with the capacitance change.

2. The sensor device of claim 1, wherein the measuring capacitance is configured to sense at least the interior compartment.

3. The sensor device of claim 1, wherein the interior compartment is immediately adjacent to the cover.

4. The sensor device of claim 1, wherein the transmitting unit emits light in the infrared range.

5. The sensor device of claim 1, wherein the at least one electrode is disposed between the transmitting unit and at least one of: the cover, the area surrounding the transmitting unit, and the area surrounding the cover.

6. The sensor device of claim 1, wherein the at least one electrode is disposed outside the interior compartment.

7. The sensor device of claim 1, wherein the sensor device is designed for sensing the optical signal reflected by a finger located on a surface of the cover and for determining an operating input or for generating an identification code in accordance with the sensed optical signal.

8. The sensor device of claim 7, wherein the evaluation unit is designed for determining the operating input by moving the finger along the surface of the cover based on a change of a speckle pattern of the optical signal sensed by the receiving unit.

9. The sensor device of claim 1, wherein the field and the means for detecting capacitance changes of the measuring capacitance generated by the at least one electrode are designed to detect a touch of a finger on the surface of the cover.

10. The sensor device of claim 1, wherein the cover is configured to be cup-shaped and the transmitting unit, the receiving unit and the evaluation unit are accommodated in a cavity defined by the cup-shaped cover.

11. The sensor device of claim 1, wherein the transmitting unit, the receiving unit and the evaluation unit are disposed on a common circuit board.

12. The sensor device of claim 10, wherein the electrode is disposed on a wall of the cup-shaped cover.

13. The sensor device of claim 12, wherein the electrode is formed by a metallic coating, preferably an aluminum coating, of the cover.

14. The sensor device of claim 1, wherein the transmitting unit is a semiconductor laser diode.

15. The sensor device of claim 1, wherein the capacitance change of the measuring capacitance is detected by means of a reference capacitance.

16. The sensor device of claim 1, further comprising:
an operating member, including a switching means; and
a movably mounted actuating part acting on the switching means in order to change the switching state of the switching means.

17. The sensor device of claim 1, wherein the sensor device is configured to be secured to a motor vehicle steering wheel.

18. The sensor device of claim 1 configured for use in a motor vehicle.

19. The sensor device of claim 1, wherein the interior compartment comprises a space region of a passenger compartment of the motor vehicle.
